(19) United States
(12) Patent Application Publication
(10) Pub. No.: US 2026/0113624 A1
(43) Pub. Date: Apr. 23, 2026

(54) UE INDICATION OF MULTI-RX CHAIN DOWNLINK RECEPTION CAPABILITY

(71) Applicant: Apple Inc., Cupertino, CA (US)

(72) Inventors: Xiang Chen, Campbell, CA (US); Haitong Sun, Cupertino, CA (US); Yang Tang, San Jose, CA (US); Dawei Zhang, Saratoga (CA); Jie Cui, San Jose, CA (US); Qiming Li, Beijing (CN); Yuexia Song, Beijing (CN); Manasa Raghavan, Sunnyvale, CA (US); Rolando E. Bettancourt Ortega, Munich, Bavaria-Bayern (DE)

(21) Appl. No.: 19/116,964

(22) PCT Filed: Sep. 30, 2022
(86) PCT No.: PCT/CN2022/123133

§ 371 Date: Mar. 28, 2025

(51) Int. Cl. H04W 8/22

(52) U.S. Cl. CPC H04W 8/22

(57) ABSTRACT

A user equipment (UE) includes a set of transceivers and a processor. The processor is configured to transmit, via the set of transceivers, a UE capability report that includes a first indication that the UE is capable of supporting multiple receive (Rx) chain downlink reception. The processor is also configured to identify a change in an operating condition of the UE, subsequent to the transmission of the UE capability report, and to transmit, via the set of transceivers and at least partly in response to the change in the operating condition, a second indication that the UE is not capable of supporting multiple Rx chain downlink reception.

### TECHNICAL FIELD

This application relates generally to wireless communication systems, including methods and apparatus for transmitting UE capability information.

### BACKGROUND

Wireless mobile communication technology uses various standards and protocols to transmit data between a network device (e.g., a base station) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of antenna panels and antenna ports that may be used to receive transmission on a downlink (DL) at a UE, according to embodiments described herein.

FIG. 2 shows a first example method of wireless communication by a UE, according to embodiments described herein.

FIG. 3 shows a second example method of wireless communication by a UE, according to embodiments described herein.

FIG. 4 shows a modified version of Table 6.3.1.1.2-8B of 3GPP Technical Specification (TS) 38.212, V17.3.0 (Release 17).

FIG. 5 shows a third example method of wireless communication by a UE, according to embodiments described herein.

FIG. 6 shows an example method of wireless communication by a network device, according to embodiments described herein.

FIG. 7 illustrates an example architecture of a wireless communication system, according to embodiments described herein.

FIG. 8 illustrates an example system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

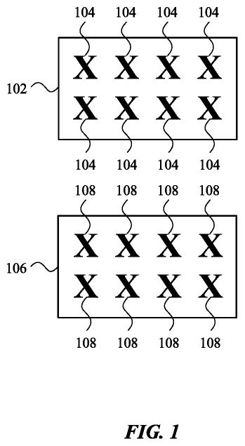

FIG. 1 shows antenna panels 102, 106 and sets of antenna ports 104, 108 that may be used to receive on a DL at a UE. A first antenna panel 102 may include a first set of antenna ports 104 that correspond to a first receive (Rx) chain. A second antenna panel 106 may include a second set of antenna ports 108 that correspond to a second Rx chain. The different antenna panels 106, 108 may be used to receive DL transmissions having different angles of arrival (AoA).

In some embodiments, a UE may operate in a multiple Rx chain configuration, and may communicate with one or more network devices (e.g., one or more network devices of a RAN) using antenna ports 104, 108 of both antenna panels 102, 106. In some embodiments, the UE may operate in a single Rx chain configuration, and may communicate with one or more network devices using antenna ports 104, 108 of only one of the antenna panels 102, 106.

In some cases, a UE may want to switch from supporting, to not supporting, multiple Rx chain DL reception. Alternatively, a UE may want to switch from not supporting, to supporting, multiple Rx chain DL reception. A UE may not want to support multiple Rx chain DL reception when, for example, its battery is low, or its temperature is too high, or when a network device is communicating with the UE using particular frequency bands or band combinations.

Currently, there is no framework for a UE to report a switch in its supported capabilities to a network. In other words, UE capability reports are static, meaning that once a UE has reported a UE capability to the network, there is no way for the UE to transmit a new UE capability report or otherwise change its UE capability with the network, unless the network initiates an additional UE capability request, which is unlikely.

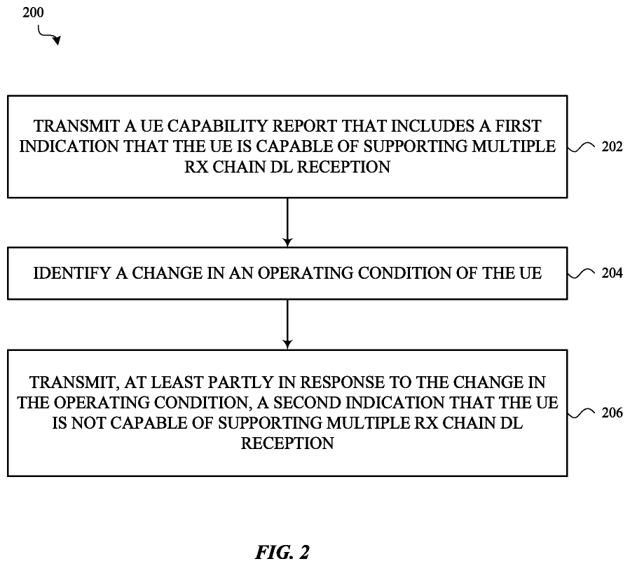

In some cases, a UE may initiate notification of a change in UE capabilities on its own (e.g., in the absence of a UE capability inquiry from a network device (e.g., a network device of a RAN)). In this regard, FIG. 2 shows a first example method 200 of wireless communication by a UE. In some cases, the UE may be the UE described with reference to FIG. 1 or one of the other UEs described herein. The method 200 may be performed using a processor, a set of transceivers (e.g., one or more transceivers), or other components of the UE.

At 202, the method 200 may include transmitting a UE capability report that includes a first indication that the UE is capable of supporting multiple Rx chain DL reception (e.g., multiple antenna panel DL reception).

At 204, the method 200 may include identifying a change in an operating condition of the UE, subsequent to the transmission of the UE capability report at 202.

At 206, the method 200 may include transmitting, at least partly in response to the change in the operating condition, a second indication that the UE is not capable of supporting multiple Rx chain DL reception.

The method 200 may be variously embodied, extended, or adapted, as described in the following paragraphs and elsewhere in this description.

In some examples of the method 200, the first indication may be transmitted to a network device (e.g., a network device of a RAN) in a UE capability report or other UE capability information, in response to a UE capability inquiry received from the network device. The first indication may be transmitted as or in a type of information element (IE), with the presence, absence, status, or value of the IE indicating that the UE is capable of supporting multiple Rx chains. In some cases, the first indication may be transmitted as a 3GPP Release 15 (Rel-15) group based beam reporting capability information element (IE) (e.g., a “groupBeamReporting” IE of the “MIMO-ParametersPerBand” IE) or as a 3GPP Release 17 (Rel-17) enhanced group based reporting capability IE (e.g., a “mTRP-GroupBasedL1-RSRP-r17” IE of the “MIMO-ParametersPerBand” IE), or as a status or value associated with the “groupBeamReporting” IE or “mTRP-GroupBasedL1-RSRP-r17” IE. When the second indication is transmitted as the “groupBeamReporting” IE or “mTRP-GroupBasedL1-RSRP-r17” IE of the “MIMO-ParametersPerBand” IE, the IE including the second indication may be transmitted along with other IEs of a UE capability report.

The change in the operating condition of the UE, identified at 204, may be (or may be based at least partly on) a change in the remaining battery power of the UE, such as the battery power of the UE falling below a threshold (e.g., a low power condition), or a transition of the UE from wired power to battery power. The change in the operating condition of the UE may alternatively be (or may alternatively or additionally be based at least partly on) a change in temperature of the UE (e.g., a device heating condition, such as a temperature of the UE rising above a temperature threshold). The change in the operating condition may alternatively or additionally be (or may be based at least partly on) other factors, such as a determination that the bandwidth of multiple Rx chain DL reception is not needed or does not substantially improve UE performance, and battery power can be saved by switching to single Rx chain DL reception.

The second indication may be transmitted in the absence of receiving an additional UE capability inquiry from a network device (e.g., a network device of a RAN). In some examples of the method 200, the second indication may be transmitted in a same type of IE as the first indication. For example, the second indication may be transmitted as a status or value of a group beam based reporting capability IE (e.g., the “groupBeamReporting” IE of the “MIMO-ParametersPerBand” IE) or an enhanced group based reporting capability IE (e.g., the “mTRP-GroupBasedL1-RSRP-r17” IE). In some examples of the method 200, the second indication may be transmitted as a parent IE without a child IE. This may be in contrast to how the first indication is transmitted (e.g., as a combination of the parent IE and the child IE). For example, the second indication may be transmitted as the “MIMO-ParametersPerBand” IE without a group beam based reporting capability IE (e.g., the “groupBeamReporting” IE of the “MIMO-ParametersPerBand” IE) or an enhanced group based reporting capability IE (e.g., the “mTRP-GroupBasedL1-RSRP-r17” IE of the “MIMO-ParametersPerBand” IE). In some examples of the method 200, the second indication may be transmitted as a second type of IE (e.g., a UE capability update IE), which second type of IE is different from a first type of IE that is used to transmit the first indication. The second type of IE may be transmitted within or outside of a MIMO capability IE (e.g., the “MIMO-ParametersPerBand” IE). In some examples, the second type of IE may be transmitted in a new type of UE capability report (i.e., a type of UE capability report that differs from the type of UE capability report transmitted at 202). In some cases, the new type of UE capability report may be a smaller UE capability report (e.g., have fewer bits) than the UE capability report transmitted at 202. In any of these examples, the second indication may indicate that the UE is switching its indication that it is capable of supporting multiple Rx chain DL reception from “support” to “not support”.

In some examples of the method 200, the second indication may not be associated with a time duration, and the second indication may remain valid until changed. For example, the second indication may remain valid until the UE makes a next UE capability report in response to a next UE capability inquiry of a network device, or until the UE initiates another notification of a change in UE capabilities (i.e., the second indication may be an indication of a semi-permanent capability of the UE).

In some examples of the method 200, the second indication may be valid for a discrete period of time (i.e., the second indication may be an indication of a temporary capability of the UE). An indication of the discrete period of time may be transmitted with the second indication, at 206, or the discrete period of time may be a predetermined or preconfigured period of time that is known by a network (e.g., a network device of a RAN) that receives the second indication. In some cases, an indication of the discrete period of time may be transmitted as a binary value that is linearly mapped to a range of possible time periods. In some cases, an indication of the discrete period of time may be transmitted as an index into a predetermined or preconfigured codebook of possible time periods. For purposes of this description, a “predetermined” period of time may be, or include, a time period that is specified by 3GPP or other technical specifications. A “preconfigured” period of time may be, or include, a time period that is indicated in radio resource control (RRC) signaling or other types of signaling or messaging.

In some examples, the method 200 may include starting a prohibit timer corresponding to transmission of the first indication, at 202, or transmission of the second indication, at 206. The prohibit timer may prevent the UE from switching its indication of support for multiple Rx chain DL reception too frequently. For example, in accordance with the method 200, the UE may need to refrain from switching an indication that the UE is capable or not capable of supporting multiple Rx chain DL reception until after expiration of the prohibit timer. The prohibit timer may correspond to X milliseconds (ms) or slots after transmitting the first indication or, similarly, X (or Y) ms or slots after transmitting the second indication.

The second indication, transmitted at 206, may be transmitted in various ways. For example, the second indication may be transmitted in a Layer 1 (L1) message (i.e., a physical layer message). Alternatively, the second indication may be transmitted in an RRC message, in a medium access control (MAC) control element (CE), or in other ways.

When the second indication is transmitted in a physical layer message, the second indication may be considered uplink control information (UCI) and transmitted on a physical uplink shared channel (PUSCH) or, in some cases, a physical uplink control channel (PUCCH). In some examples, the second indication may be transmitted as a new type of feedback information—e.g., as a capability update type of channel state information (CSI) feedback. The capability update type of CSI feedback may have the same priority as existing CSI feedback (e.g., the same priority as L1 reference signal received power (RSRP) (L1-RSRP) feedback or L1 signal-to-interference-plus-noise ratio (SINR) (L1-SINR) feedback), or the capability update type of CSI feedback may have a different priority (e.g., a higher priority compared to the priority of L1-RSRP feedback or L1-SINR feedback). In some examples, the second indication may be transmitted as a capability update type of UCI (e.g., in contrast to existing scheduling request (SR), hybrid automatic repeat request (HARQ) acknowledgment (ACK) (HARQ-ACK), CSI, or configured grant (CG) types of UCI). When the second indication is transmitted as a capability update type of UCI, the capability update type of UCI may be encoded by itself using a polar code, or the capability update type of UCI may be jointly encoded with other types of UCI using a polar code.

When the second indication is transmitted in an RRC message or MAC CE, the second indication may be transmitted using an uplink (UL) grant for PUSCH transmission, assuming that the UE already has an UL grant for PUSCH transmission. If the UE does not already have an UL grant for PUSCH transmission, the UE may request an UL grant via a SR, or the UE may perform a random access channel (RACH) procedure.

If the UE is in an RRC_CONNECTED state and needs to request an UL grant via a SR, the UE may in some cases use an existing SR format to obtain an UL grant for transmitting the second indication (or for transmitting other updated UE capability information). Alternatively, the UE may receive, from a network device (e.g., a network device of a RAN), an indication of one or more SR resources dedicated for transmitting a SR to report updated UE capability information (or an updated indication of support (or no support) for multiple Rx chain DL reception). For the purpose of UCI multiplexing and collision handling, a SR used to report updated UE capability information may have the same priority or a different priority compared to other SRs.

If the UE has lost its synchronization with UL timing, or if the UE is not in an RRC_CONNECTED state, the UE may perform a RACH procedure to acquire the UL timing and, subsequently, transmit the second indication at 206. In these cases, the UE may perform a contention-free random access (CFRA) procedure or a contention-based random access (CBRA) procedure.

Similarly to what is described in method 200, a UE may indicate that it is not capable of supporting multiple Rx chain DL reception, and then switch to indicating that it is capable of supporting multiple Rx chain DL reception, by transmitting one or more IEs corresponding to a switch from does “not support” to “supports”. The UE may also switch back and forth between not supporting and supporting multiple Rx chain DL reception, but in some cases may be limited in how frequently it switches (e.g., as a result of a prohibit timer).

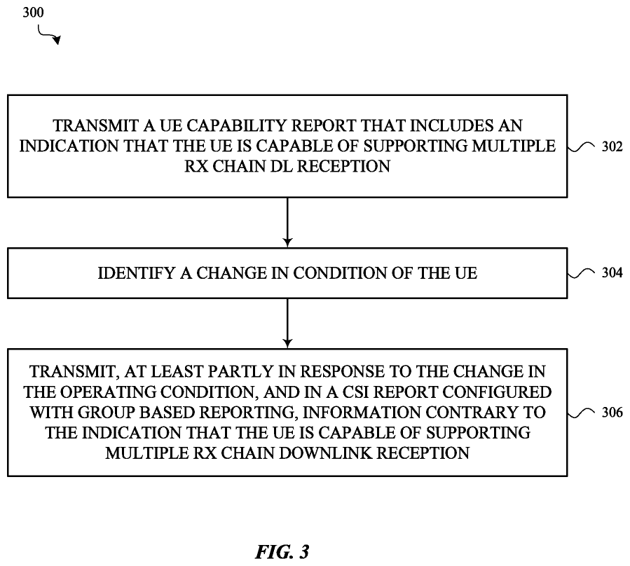

FIG. 3 shows a second example method 300 of wireless communication by a UE. In some cases, the UE may be the UE described with reference to FIG. 1 or one of the other UEs described herein. The method 300 may be performed using a processor, a set of transceivers (e.g., one or more transceivers), or other components of the UE.

At 302, the method 300 may include transmitting a UE capability report that includes a first indication that the UE is capable of supporting multiple Rx chain DL reception (e.g., multiple antenna panel DL reception).

At 304, the method 300 may include identifying a change in an operating condition of the UE, subsequent to the transmission of the UE capability report at 202.

At 306, the method 300 may include transmitting, at least partly in response to the change in the operating condition, and in a CSI report configured with group based reporting, information contrary to the indication that the UE is capable of supporting multiple Rx chain DL reception.

The method 300 may be variously embodied, extended, or adapted, as described in the following paragraphs and elsewhere in this description.

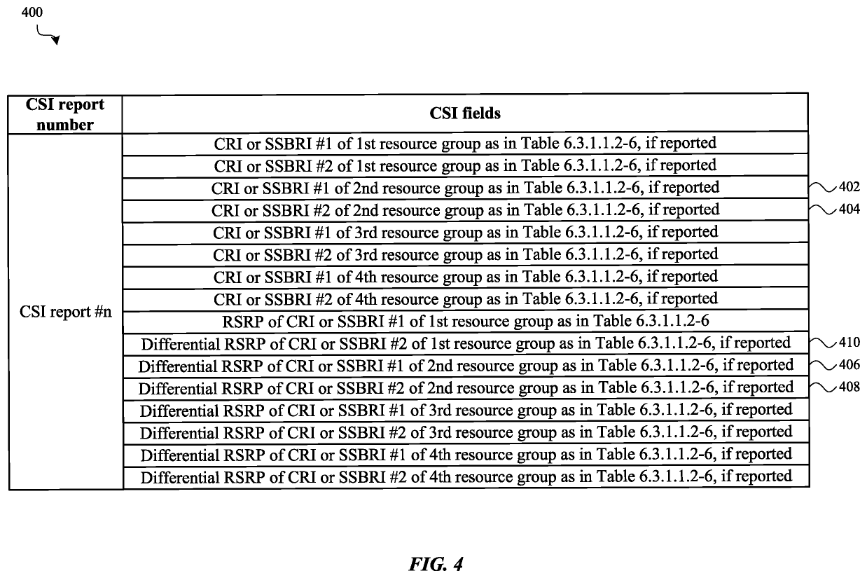

In accordance with current 3GPP technical specifications, when a CSI report is configured with group based reporting (i.e., group based beam reporting), a UE is supposed to report, for each resource group configured by a network device (i.e., for each resource group configured to be received by the UE at a different AoA, from a network device of a RAN), information for a pair of beams (i.e., a pair of Rx beams) that may be used for simultaneous DL reception. See, e.g., table 400 of FIG. 4, which is a modified version of Table 6.3.1.1.2-8B of 3GPP Technical Specification (TS) 38.212, V17.3.0 (Rel-17). The information may include an identity of each beam, and a differential RSRP measurement for each beam (except for the beam identified by “CRI or SSBRI #1 of 1st resource group as in Table 6.3.1.1.2-6” with respect to the “RSRP of CRI or SSBRI #1 of 1st resource group as in Table 6.3.1.1.2-6”). The UE may report the identities of a pair of beams, for a resource group, by reporting a pair of CSI reference signal (RS) (CSI-RS) RIs (CRIs) or a pair of synchronization signal block (SSB) RIs (SSBRIs). For example, the UE may report a “CRI or SSBRI #1” and a “CRI or SSBRI #2”, for a 2nd resource group, at 402 and 404. The UE may also report a differential RSRP for “CRI or SSBRI #1” and a differential RSRP for “CRI or SSBRI #2”, for the 2nd resource group, at 406 and 408. If, however, the UE does not provide the required information (e.g., the “Differential RSRP of CRI or SSBRI #1 of 1st resource group as in Table 6.3.1.1.2-6”), a network device may interpret the missing information to mean that the UE is no longer capable of supporting multiple Rx chain DL reception. For example, as shown in table 400, the current language of line 410 of Table 6.3.1.1.2-8B may be modified from “Differential RSRP of CRI or SSBRI #1 of 1st resource group as in Table 6.3.1.1.2-6” to “Differential RSRP of CRI or SSBRI #1 of 1st resource group as in Table 6.3.1.1.2-6, if reported” (i.e., changing the UE's report of the “Differential RSRP of CRI or SSBRI #1 of 1st resource group as in Table 6.3.1.1.2-6” from mandatory to optional). If the UE does not report the “Differential RSRP of CRI or SSBRI #1 of 1st resource group as in Table 6.3.1.1.2-6”, a network device knows that the UE is no longer capable of supporting multiple Rx chain DL reception.

Similarly to what is described in method 300, a UE may indicate that it is not capable of supporting multiple Rx chain DL reception, and then switch to indicating that it is capable of supporting multiple Rx chain DL reception, by providing, in a CSI report configured with group based reporting, all of the information that a network device needs to support multiple Rx chain downlink reception by the UE. The UE may also switch back and forth between not supporting and supporting multiple Rx chain DL reception, but in some cases may be limited in how frequently it switches (e.g., as a result of a prohibit timer).

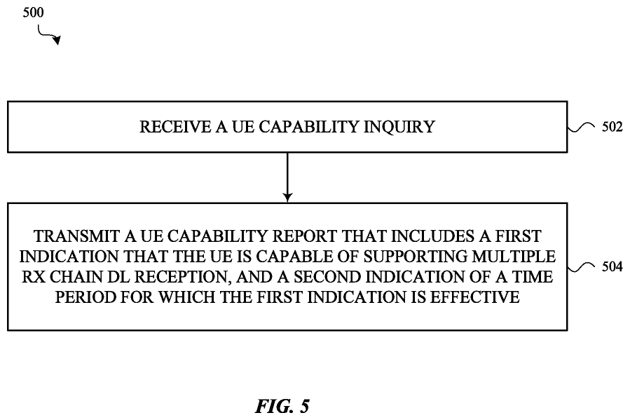

FIG. 5 shows a third example method 500 of wireless communication by a UE. In some cases, the UE may be the UE described with reference to FIG. 1 or one of the other UEs described herein. The method 500 may be performed using a processor, a set of transceivers (e.g., one or more transceivers), or other components of the UE.

At 502, the method 500 may include receiving a UE capability inquiry (e.g., from a network device of a RAN).

At 504, the method 500 may include transmitting a UE capability report that includes a first indication that the UE is capable of supporting multiple Rx chain DL reception, and a second indication of a time period for which the first indication is effective.

The method 500 may be variously embodied, extended, or adapted, as described in the following paragraphs and elsewhere in this description.

When the time period expires, a network device (e.g., a network device of a RAN) may consider the first indication to be invalid and assume that the UE no longer supports multiple Rx chain DL reception. Similarly, when the time period expires, the UE need not support multiple Rx chain DL reception.

In some examples of the method 500, the second indication may be transmitted as a binary value that is linearly mapped to a range of possible time periods. In some examples of the method 500, the second indication may be transmitted as an index into a predetermined or preconfigured codebook of possible time periods. For purposes of this description, a “predetermined” period of time may be, or include, a time period that is specified by 3GPP or other technical specifications. A “preconfigured” period of time may be, or include, a time period that is indicated in RRC signaling or other types of signaling or messaging. In some examples, the second indication may indicate a time period of ‘0’, or another predetermined value, which may indirectly indicate to the network that the UE does not support multiple Rx chain DL reception.

When the time period indicated at 504 expires, or at a time near expiration of the time period, a network device (e.g., a network device of a RAN) may initiate another UE capability inquiry to determine whether the UE provides a new time period, thereby resetting or extending the UE's support of multiple Rx chain DL reception. Alternatively or additionally, the UE may initiate an override, reset, or extension of the time period for which the UE supports multiple Rx chain DL reception. Such an override, reset, or extension of the time period may be indicated, for example, in an RRC message, a MAC CE, or a physical layer message (i.e., an L1 message).

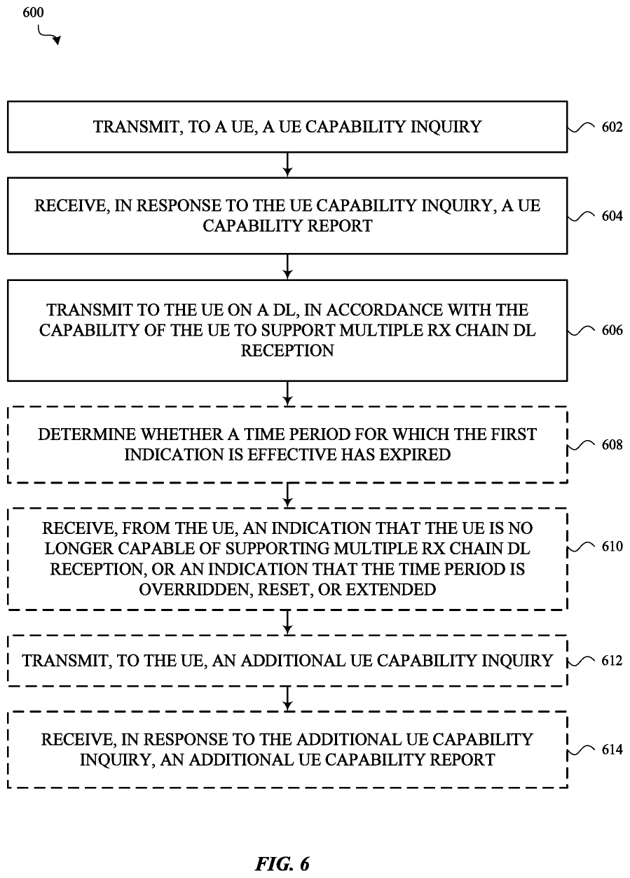

FIG. 6 shows an example method 600 of wireless communication by a network device (e.g., a network device of a RAN). In some cases, the network device may be one of the network devices described in other figures herein. The method 600 may be performed using a processor, a set of transceivers (e.g., one or more transceivers), or other components of the network device.

At 602, the method 600 may include transmitting, to the UE, a UE capability inquiry.

At 604, and in response to the UE capability inquiry, the method 600 may include receiving a UE capability report. The UE capability report may include an indication that a UE is capable of supporting multiple Rx chain DL reception (e.g., multiple antenna panel DL reception).

At 606, the method 600 may include transmitting to the UE on a DL, in accordance with the capability of the UE to support multiple Rx chain DL reception.

At 608, the method 600 may optionally include determining whether a time period for which the first indication is effective has expired.

At 610, the method 600 may optionally include receiving, from the UE, an indication (e.g., one or more IEs, a CSI report, etc.) that the UE is no longer capable of supporting multiple Rx chain DL reception, or an indication that the time period is overridden, reset, or extended.

At 612, the method 600 may optionally include transmitting, to the UE, an additional UE capability inquiry.

At 614, and in response to the additional UE capability inquiry, the method 600 may include receiving an additional UE capability report.

The method 600 may be variously embodied, extended, or adapted, as described with reference to FIGS. 2-5 and elsewhere in this description. In some examples, the UE may indicate that it does not support multiple Rx chain DL reception at 604, and indicate that it supports multiple Rx chain DL reception at 610.

Embodiments contemplated herein include one or more non-transitory computer-readable media storing instructions to cause an electronic device, upon execution of the instructions by one or more processors of the electronic device, to perform one or more elements of the method 200, 300, 500, or 600. In the context of method 200, 300, or 500, this non-transitory computer-readable media may be, for example, a memory of a UE (such as a memory 806 of a wireless device 802 that is a UE, as described herein). In the context of method 600, this non-transitory computer-readable media may be, for example, a memory of a network device (such as a memory 824 of a network device 820, as described herein).

Embodiments contemplated herein include an apparatus having logic, modules, or circuitry to perform one or more elements of the method 200, 300, 500, or 600. In the context of method 200, 300, or 500, this apparatus may be, for example, an apparatus of a UE (such as a wireless device 802 that is a UE, as described herein). In the context of method 600, this apparatus may be, for example, an apparatus of a network device (such as a network device 820, as described herein).

Embodiments contemplated herein include an apparatus having one or more processors and one or more computer-readable media, using or storing instructions that, when executed by the one or more processors, cause the one or more processors to perform one or more elements of the method 200, 300, 500, or 600. In the context of method 200, 300, or 500, this apparatus may be, for example, an apparatus of a UE (such as a wireless device 802 that is a UE, as described herein). In the context of the method 600, this apparatus may be, for example, an apparatus of a network device (such as a network device 820, as described herein).

Embodiments contemplated herein include a signal as described in or related to one or more elements of the method 200, 300, 500, or 600.

Embodiments contemplated herein include a computer program or computer program product having instructions, wherein execution of the program by a processor causes the processor to carry out one or more elements of the method 200, 300, 500, or 600. In the context of method 200, 300, or 500, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein). In the context of method 600, the processor may be a processor of a network device (such as a processor(s) 822 of a network device 820, as described herein), and the instructions may be, for example, located in the processor and/or on a memory of the network device (such as a memory 824 of a network device 820, as described herein).

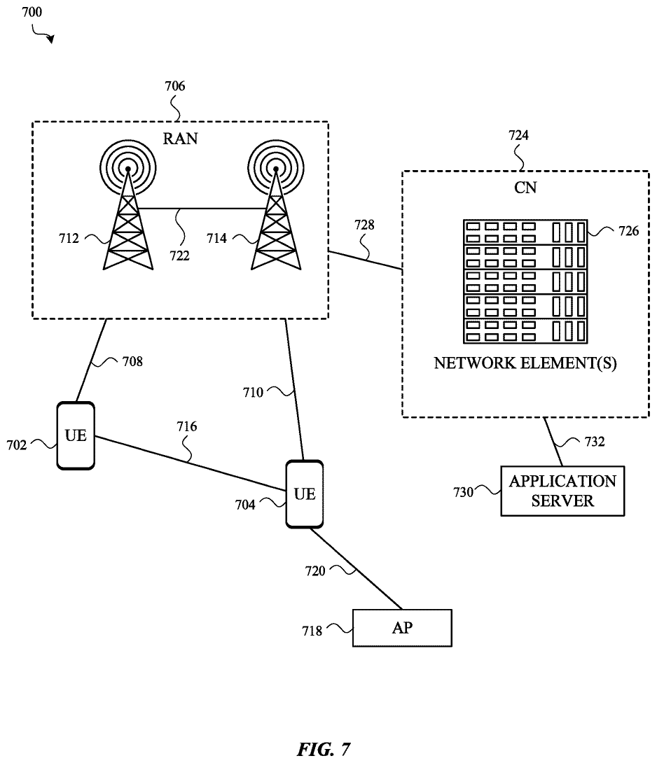

FIG. 7 illustrates an example architecture of a wireless communication system, according to embodiments described herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more network devices, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more network devices of a RAN (e.g., two or more eNBs and the like) that connect to an EPC, and/or between two eNBs connecting to the EPC. In embodiments where the wireless communication system 800 is an NR system (e.g., when CN 724 is a 5GC), the interface 722 may be an Xn interface. The Xn interface is defined between two or more network devices of a RAN (e.g., two or more gNBs and the like) that connect to the 5GC, between a base station 712 (e.g., a gNB) connecting to the 5GC and an eNB, and/or between two eNBs connecting to the 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

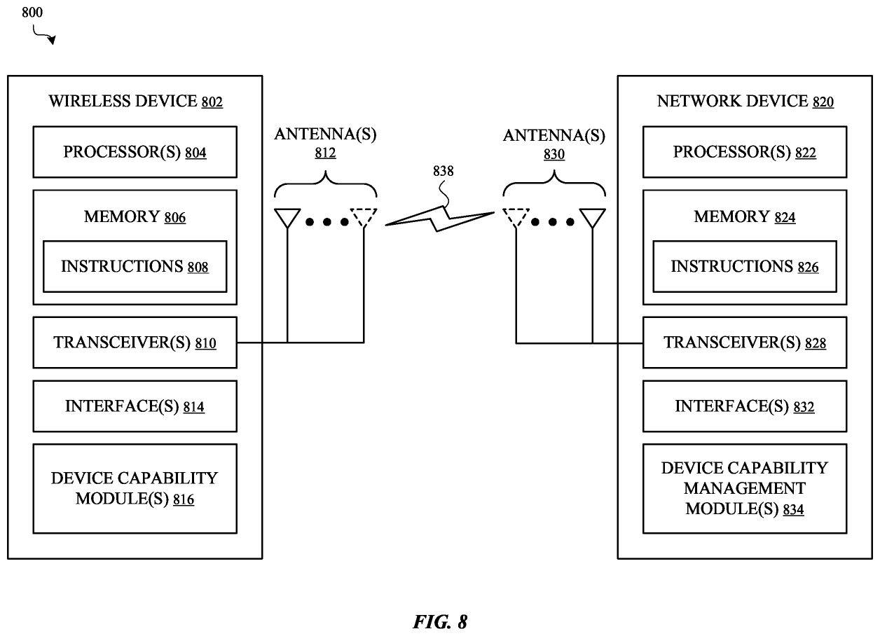

FIG. 8 illustrates a system 800 for performing signaling 838 between a wireless device 802 and a network device 820, according to embodiments described herein. The system 800 may be a portion of a wireless communication system as herein described. The wireless device 802 may be, for example, a UE of a wireless communication system. The network device 820 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 838) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include device capability module(s) 816. The device capability module(s) 816 may be implemented via hardware, software, or combinations thereof. For example, the device capability module(s) 816 may be implemented as a processor, circuit, and/or instructions 808 stored in the memory 806 and executed by the processor(s) 804. In some examples, the device capability module(s) 816 may be integrated within the processor(s) 804 and/or the transceiver(s) 810. For example, the device capability module(s) 816 may be implemented by a combination of software components (e.g., executed by a DSP or a general processor) and hardware components (e.g., logic gates and circuitry) within the processor(s) 804 or the transceiver(s) 810.

The device capability module(s) 816 may be used for various aspects of the present disclosure, for example, aspects of FIGS. 1-6, from a wireless device or UE perspective. The device capability module(s) 816 may be configured to, for example, indicate to the network device 820 whether the wireless device 802 supports or does not support multiple Rx chain DL reception. The device capability module(s) 816 may also be configured to, for example, indicate to the network device 820 when the wireless device 802 has made a switch in regard to its support of multiple Rx chain DL reception.

The network device 820 may include one or more processor(s) 822. The processor(s) 822 may execute instructions such that various operations of the network device 820 are performed, as described herein. The processor(s) 822 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 838) to and/or from the network device 820 with other devices (e.g., the wireless device 802) according to corresponding RATs.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820 that is a base station may include interface(s) 832 made up of transmitters, receivers, and other circuitry (e.g., other than the transceiver(s) 828/antenna(s) 830 already described) that enables the base station to communicate with other equipment in a network, and/or that enables the base station to communicate with external networks, computers, databases, and the like for purposes of operations, administration, and maintenance of the base station or other equipment operably connected thereto.

The network device 820 may include one or more device capability management module(s) 834. The device capability management module(s) 834 may be implemented via hardware, software, or combinations thereof. For example, the device capability management module(s) 834 may be implemented as a processor, circuit, and/or instructions 826 stored in the memory 824 and executed by the processor(s) 822. In some examples, the device capability management module(s) 834 may be integrated within the processor(s) 822 and/or the transceiver(s) 828. For example, the device capability management module(s) 834 may be implemented by a combination of software components (e.g., executed by a DSP or a general processor) and hardware components (e.g., logic gates and circuitry) within the processor(s) 822 or the transceiver(s) 828.

The device capability management module(s) 834 may be used for various aspects of the present disclosure, for example, aspects of FIGS. 1-6, from a network device perspective. The device capability management module(s) 834 may be configured to, for example, determine whether the wireless device 802 supports or does not support multiple Rx chain DL reception.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a set of transceivers; and
a processor configured to,
transmit, via the set of transceivers, a UE capability report that includes a first indication that the UE is capable of supporting multiple receive (Rx) chain downlink reception;
identify a change in an operating condition of the UE, subsequent to the transmission of the UE capability report; and
transmit, via the set of transceivers and at least partly in response to the change in the operating condition, a second indication that the UE is not capable of supporting multiple Rx chain downlink reception.

2. The UE of claim 1, wherein the identified change in the operating condition comprises at least one of a low power condition or a device heating condition.

3. The UE of claim 1, wherein the first indication and the second indication are transmitted in a same type of information element (IE).

4. The UE of claim 1, wherein:
the first indication is transmitted as a combination of a parent IE and a child IE of the parent IE; and
the second indication is transmitted as the parent IE without the child IE.

5. The UE of claim 1, wherein:
the first indication is transmitted as a first type of IE; and
the second indication is transmitted as a second type of IE.

6. The UE of claim 1, wherein the second indication is valid until the processor transmits a next UE capability report or initiates a notification of a change in UE capabilities.

7. The UE of claim 1, wherein the second indication is valid for a discrete period of time.

8. The UE of claim 7, wherein an indication of the discrete period of time is transmitted with the second indication.

9. The UE of claim 7, wherein the discrete period of time is a predetermined or preconfigured period of time that is known by a network device that receives the second indication.

10. The UE of claim 1, wherein:
the processor is configured to,
start a prohibit timer corresponding to transmission of the first indication or transmission of the second indication; and
refrain from switching an indication that the UE is capable or not capable of supporting multiple Rx chain downlink reception until after expiration of the prohibit timer.

11. The UE of claim 1, wherein the second indication is transmitted in a physical layer message.

12. The UE of claim 11, wherein the second indication is transmitted as a capability update type of channel state information (CSI) feedback.

13. The UE of claim 12, wherein the capability update type of CSI feedback has a higher priority than Layer 1 (L1) reference signal received power (RSRP) (L1-RSRP) feedback and L1 signal-to-interference-plus-noise ratio (SINR) (L1-SINR) feedback.

14. The UE of claim 11, wherein the second indication is transmitted as a capability update type of uplink control information (UCI) and jointly encoded with at least one other type of UCI using a polar code.

15. The UE of claim 12, wherein the second indication is transmitted in a medium access control (MAC) control element (CE) (MAC CE) or radio resource control (RRC) signaling.

16. The UE of claim 1, wherein:
the processor is configured to,
receive, via the set of transceivers, an indication of a scheduling request (SR) resource dedicated for transmitting a SR to report updated UE capability information;
transmit, via the set of transceivers and using the SR resource, the SR;
receive, via the set of transceivers and in response to transmitting the SR, an UL grant for PUSCH transmission; and
transmit the second indication using the UL grant for PUSCH transmission.

17. A user equipment (UE), comprising:
a set of transceivers; and
a processor configured to,
transmit, via the set of transceivers, a UE capability report that includes an indication that the UE is capable of supporting multiple receive (Rx) chain downlink reception;
identify a change in an operating condition of the UE, subsequent to the transmission of the UE capability report; and
transmit, via the set of transceivers, at least partly in response to the change in the operating condition, and in a channel state information (CSI) report configured with group based reporting, information contrary to the indication that the UE is capable of supporting multiple Rx chain downlink reception.

18. The UE of claim 17, wherein the information contrary to the indication that the UE is capable of supporting multiple Rx chain downlink reception comprises, for a resource group in the CSI report, information for only one receive beam.

19. A user equipment (UE), comprising:
a set of transceivers; and
a processor configured to,
receive, via the set of transceivers, a UE capability inquiry; and
transmit, via the set of transceivers, a UE capability report that includes,
a first indication that the UE is capable of supporting multiple receive (Rx) chain downlink reception; and
a second indication of a time period for which the first indication is effective.

20. The UE of claim 19, wherein:
the processor is configured to,
identify a change in an operating condition of the UE; and
transmit, via the set of transceivers, a message that overrides the time period.
